(19) United States
(12) Patent Application Publication
(10) Pub. No.: US 2021/0303691 A1
(43) Pub. Date: Sep. 30, 2021

(54) IP INDEPENDENT SECURE FIRMWARE LOAD

(71) Applicant: Intel Corporation, Santa Clara, CA (US)

(72) Inventors: Prashant Dewan, Portland, OR (US); Karunakara Kotary, Portland, OR (US); Nivedita Aggarwal, Portland, OR (US); Vinupama Godavarthi, Folsom, CA (US); Aditya Katragada, Austin, TX (US); Mohamed Haniffa, Tirunelveli (IN); Tung Lun Loo, Bayan Lepas (MY)

(73) Assignee: Intel Corporation, Santa Clara, CA (US)

(21) Appl. No.: 16/832,416

(22) Filed: Mar. 27, 2020

(51) Int. Cl. G06F 21/57

(52) U.S. Cl. CPC G06F 21/572; G06F 2221/033

(57) ABSTRACT

An apparatus to implement an IP independent firmware load is disclosed. The apparatus includes a plurality of agents, a plurality of agents, at least one agent including a memory to store firmware to be executed by the agent to perform a function associated with the agent and a register to store enumeration data for the firmware load mechanism of the IP, and a processor to initiate an enumeration process to read the enumeration data from the register of the at least one agent, make a decision based on that data to retrieve a firmware module from a storage device, verify the firmware module, and load the firmware module into the memory of the at least one agent.

### BACKGROUND OF THE DESCRIPTION

A system on chip (SOC) is an integrated circuit that integrates all components of a computer or other electronic system. These components may include a central processing unit (CPU), memory, input/output (IO) ports and secondary storage, which are all included on a single substrate or microchip. Additionally, SOCs enable the integration of third-party components via a standardized on-die interconnect protocol. However, the addition of such components may lead to security vulnerabilities.

### BRIEF DESCRIPTION OF THE DRAWINGS

So that the manner in which the above recited features of the present subject matter can be understood in detail, a more particular description of the subject mailer, briefly summarized above, may be had by reference to embodiments, some of which are illustrated in the appended drawings. It is to be noted, however, that the appended drawings illustrate only typical embodiments of this subject matter and are therefore not to be considered limiting of its scope, for the subject matter may admit to other equally effective embodiments.

FIG. 1 is a schematic illustration of one embodiment of a computing device, according to examples.

FIGS. 2A-2C are schematic illustrations of a computing platform, according to embodiments.

FIG. 3 is a schematic illustration of an IP agent, according to embodiments.

FIG. 4A is a flow diagram illustrating operations in a method to implement an IP independent secure firmware load, according to embodiments.

FIG. 4B is a ping-pong diagram illustrating operations in a method to implement an IP independent secure firmware load, according to embodiments.

FIG. 5 is a schematic illustration of an electronic device which may be adapted to implement an IP independent secure firmware load, according to embodiments.

### DETAILED DESCRIPTION

In the following description, numerous specific details are set forth to provide a more thorough understanding of the present subject matter. However, it will be apparent to one of skill in the art that the present subject matter may be practiced without one or more of these specific details. In other instances, well-known features have not been described in order to avoid obscuring the present subject matter.

References to “one embodiment”, “an embodiment”, “example embodiment”, “various embodiments”, etc., indicate that the embodiment(s) so described may include particular features, structures, or characteristics, but not every embodiment necessarily includes the particular features, structures, or characteristics. Further, some embodiments may have some, all, or none of the features described for other embodiments.

In the following description and claims, the term “coupled” along with its derivatives, may be used. “Coupled” is used to indicate that two or more elements co-operate or interact with each other, but they may or may not have intervening physical or electrical components between them.

As used in the claims, unless otherwise specified, the use of the ordinal adjectives “first”, “second”, “third”, etc., to describe a common element, merely indicate that different instances of like elements are being referred to, and are not intended to imply that the elements so described must be in a given sequence, either temporally, spatially, in ranking, or in any other manner.

Designers of integrated circuits such as systems-on-a-chip (SoCs), microprocessors, microcontrollers, and other systems may use intellectual property (IP) blocks to simplify system design. An IP block is a modular, self-contained hardware block that can be easily integrated into the design. Because the IP block is modular and self-contained, the integrated circuit (IC) designer need only “drop in” the IP block to use the functionality of the IP block. The system designer can then make the appropriate connections to inputs and outputs.

IP blocks are often “black boxes.” In other words, the system integrator using the IP block may not know, and need not know, the specific implementation details of the IP block. Indeed, IP blocks may be provided as proprietary third-party units, with no insight into the design of the IP block by the system integrator.

For example, a system integrator designing an SoC for a smart phone may use IP blocks in addition to the processor core, such as a memory controller, a nonvolatile memory (NVM) controller, Wi-Fi, Bluetooth, GPS, a fourth or fifth-generation network (4G or 5G), an audio processor, a video processor, an image processor, a graphics engine, a graphics processing unit (GPU) engine, a security controller, and many other IP blocks. In many cases, each of these IP blocks has its own embedded microcontroller, and the microcontroller has its own architecture, instruction sets, and firmware loading requirements. Because there is no standardized microcontroller architecture or set of firmware loading requirements, custom firmware loading procedures may be designed for each IP block.

In an illustrative example, an SoC integrator integrates IP blocks with controllers designed in-house and externally across a wide range of vendors, architectures, bus interfaces, and boot time characteristics. These may all be designed independently of one another, particularly with respect to the loading of the firmware that runs on the microcontrollers of the IP blocks. There is presently no hardware standard that exists with respect to IP block firmware loading mechanisms. This can make IP integration with SoCs difficult and expensive.

The requirement for custom flows for IP firmware loading has drawbacks. For example, it prevents the re-use of designs with different IP blocks. In some instances, vendor lock-in may occur, because the SoC has been designed around the IP block of a particular vendor. Replacing the IP block with a functionally identical IP block from a different vendor may be expensive, because the firmware loading mechanism needs to be completely redesigned. This increases the cost of SoC and software integration. It also increases the effort required for security validation, and overall increases the cost of all stages of the security development lifecycle (SDL).

Some examples described herein may utilize a firmware load interface, also called a “dashboard,” that provides a standard mechanism for loading firmware to an IP block. The hardware dashboard may be provided either internally within the IP block, or, for compatibility with legacy IP blocks that lack the firmware dashboard, the firmware dashboard itself could be provided as a separate IP block. The hardware dashboard has an IP-facing interface that provides customized instructions and processes specific to the IP, and also includes a system-facing interface that provides a standardized interface common to all IP blocks or classes of IP blocks. This provides a vendor-agnostic firmware load interface which ensures that if an IP block is replaced with a functionally similar or identical IP block from another vendor, the system does not need to be redesigned. This can provide either a direct, drop-in replacement (i.e., in a case where the firmware dashboard is provided internally to the IP block), or, at worst, the firmware dashboard IP is replaced with the corresponding firmware dashboard IP for the vendor of the new IP block. Other aspects of the system, including BIOS, firmware, and software, need not be compatible with the new IP block, because they are able to operate with the standardized firmware dashboard.

The firmware dashboard provides an interface that is not only vendor-agnostic, but also architecture-agnostic. ARM, AMD, Intel®, and other architectures can be integrated with any IP that provides a corresponding firmware dashboard. In cases where a trusted execution environment (TEE) is used for security, the firmware dashboard may also be compatible with, for example, Trusty, VBS, security controller, early BIOS, or any other TEE mechanism. This allows for TEE-agnostic loading of secure firmware for devices. For example, the firmware dashboard could be used on an ARM, AMD, or Intel® SoC, and may be used to integrate IP blocks from any number of vendors. This provides not only secure input/output (I/O), but also secure offloading of compute functionality to accelerators, which is useful in data centers.

The firmware dashboard of the present specification overcomes difficulties that arise because multiple architectures and multiple TEEs exist in common usage today. IP providers generally have their own, independently-designed hardware and custom expectations for software for their IP firmware. In the absence of a common mechanism, it can be very difficult for an SoC integrator to mix-and-match IP to multiple vendors. Furthermore, some vendors couple firmware loading of one IP with other IPs, thereby creating intractable dependencies. For example, if IP A is dependent on IP B to load secure firmware, and IP B is dependent on IP C and fabric D for its existence, the SoC design becomes challenging and sub-optimal.

The present specification implements a hardware widget known as a firmware load interface for a firmware “dashboard” that extracts information required for IP firmware loading, and exposes a general standard interface external to the IP. Even though the IP is designed with custom flows, it has some generic expectations for external agents, and architecture for firmware verification and loading. The firmware dashboard disclosed herein uses these generalizations to create standard hardware widgets that are universally pluggable, and provide a standard external flow for firmware loading and verification. Internal implementations on the IP side may still be different from IP to IP.

The firmware dashboard supports multiple styles of access control, including, for example, range-based, TLP bit-based, and access control based on boot stages. Furthermore, it encapsulates all interactions between the IP and the SoC, as well as the IP and other IPs inside the SoC for IP firmware management.

Advantageously, IPs may be designed independently of one another, which SoCs they're integrated into, and which OS or software are used on those SoCs. So with the firmware dashboard, IPs can be reused across many different architectures. Furthermore, software components such as BIOS or OS drivers may re-use IP firmware load modules from one IP to another, and also port from one platform to another, or from one ecosystem to another. This enables fast SoC integration with reduced validation costs in software for third-party IPs. It also provides improved security assurance with respect to IP firmware integrity, due to standardization.

The present specification illustrates the use of a firmware load interface, or dashboard, in terms of three types of IP blocks. It should be noted that these flavors are presented for illustrative purposes only, and that other types of IP blocks with other firmware load characteristics may be provided.

Type 1 is an IP with a read-only memory (ROM) and built-in hardware crypto. This IP block is able to establish its own root of trust, but depends on an external agent like an operating system or another controller to copy the firmware to an SoC-addressable memory for it to load. The IP may then use direct memory access (DMA) to access and verify the firmware, and to start executing it.

Type 2 is an IP with no ROM or crypto. It depends purely on an external entity to verify the integrity of the firmware, and download it into an internal random access memory (RAM), such as a static RAM (SRAM) or a register file.

Type 3 is an IP with no internal ROM or crypto. It expects an external agent to load and verify the firmware. The external agent must then point the firmware to the IP. The IP directly executes from that external memory.

A system and method for providing IP independent secure firmware load is described with more particular reference to the attached figures. It should be noted that throughout the figures, certain reference numerals may be repeated to indicate that a particular device or block is wholly or substantially consistent across the figures. This is not, however, intended to imply any particular relationship between the various embodiments disclosed. In certain examples, a genus of elements may be referred to by a particular reference numeral (“widget 10”), while individual species or examples of the genus may be referred to by a hyphenated numeral (“first specific widget 10-1” and “second specific widget 10-2”).

Certain of the figures below detail example architectures and systems to implement embodiments of the above. In some embodiments, one or more hardware components and/or instructions described above are emulated as detailed below, or implemented as software modules.

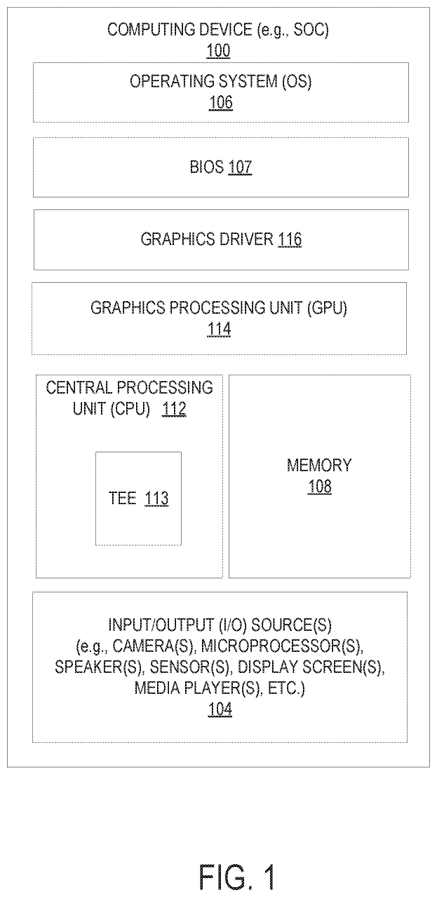

FIG. 1 is a schematic illustration of one embodiment of a computing device, according to examples. According to one embodiment, computing device 100 comprises a computer platform hosting an integrated circuit (“IC”), such as a system on a chip (“SoC” or “SOC”), integrating various hardware and/or software components of computing device 100 on a single chip. As illustrated, in one embodiment, computing device 100 may include any number and type of hardware and/or software components, such as (without limitation) graphics processing unit 114 (“GPU” or simply “graphics processor”), graphics driver 116 (also referred to as “GPU driver”, “graphics driver logic”, “driver logic”, user-mode driver (UMD), UMD, user-mode driver framework (UMDF), UMDF, or simply “driver”), central processing unit 112 (“CPU” or simply “application processor”), a trusted execution environment (TEE) 113, memory 108, network devices, drivers, or the like, as well as input/output (I/O) sources 104, such as touchscreens, touch panels, touch pads, virtual or regular keyboards, virtual or regular mice, ports, connectors, etc. Computing device 100 may include operating system (OS) 106 serving as an interface between hardware and/or physical resources of computing device 100 and a user and a basic input/output system (BIOS) 107 which may be implemented as firmware and reside in a non-volatile section of memory 108.

It is to be appreciated that a lesser or more equipped system than the example described above may be preferred for certain implementations. Therefore, the configuration of computing device 100 may vary from implementation to implementation depending upon numerous factors, such as price constraints, performance requirements, technological improvements, or other circumstances.

Embodiments may be implemented as any or a combination of: one or more microchips or integrated circuits interconnected using a parentboard, hardwired logic, software stored by a memory device and executed by a microprocessor, firmware, an application specific integrated circuit (ASIC), and/or a field programmable gate array (FPGA). The terms “logic”, “module”, “component”, “engine”, and “mechanism” may include, by way of example, software or hardware and/or a combination thereof, such as firmware.

Embodiments may be implemented using one or more memory chips, controllers, CPUs (Central Processing Unit), microchips or integrated circuits interconnected using a motherboard, an application specific integrated circuit (ASIC), and/or a field programmable gate array (FPGA). The term “logic” may include, by way of example, software or hardware and/or combinations of software and hardware.

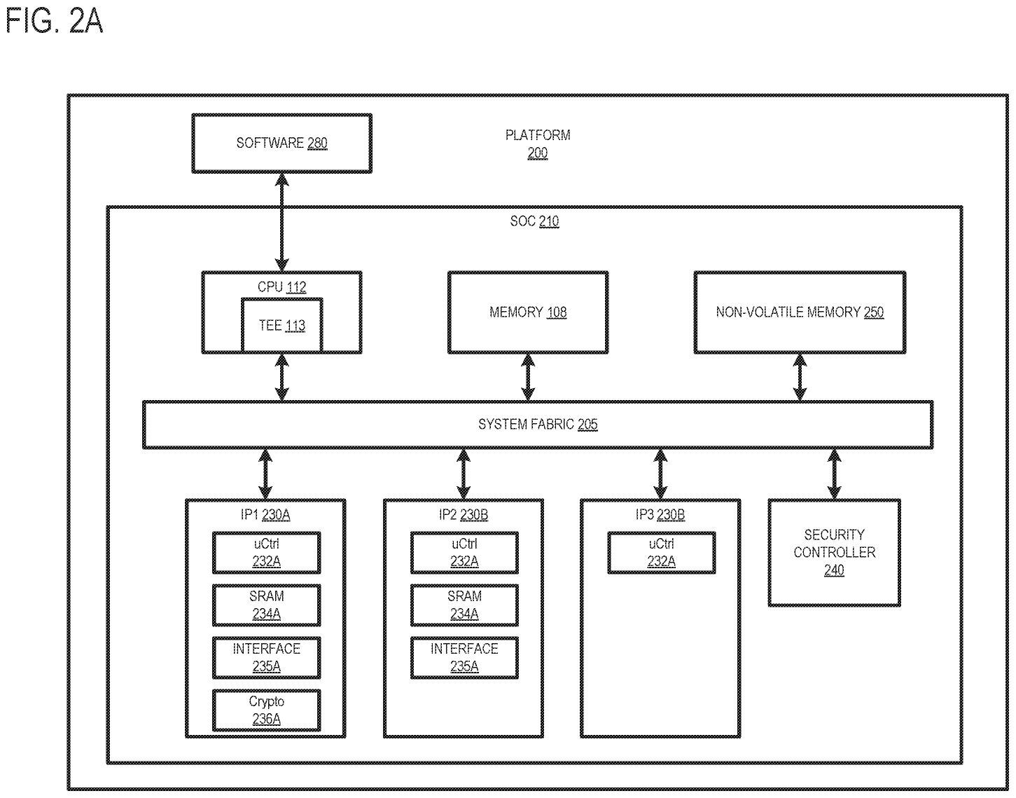

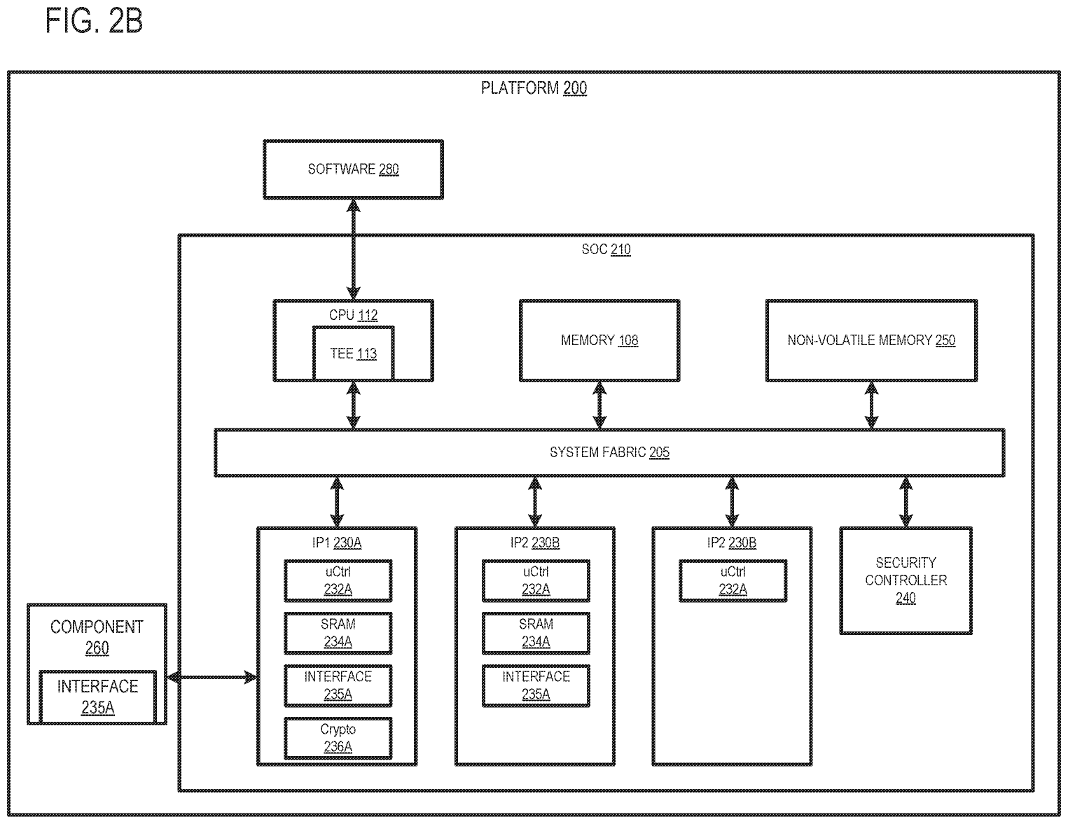

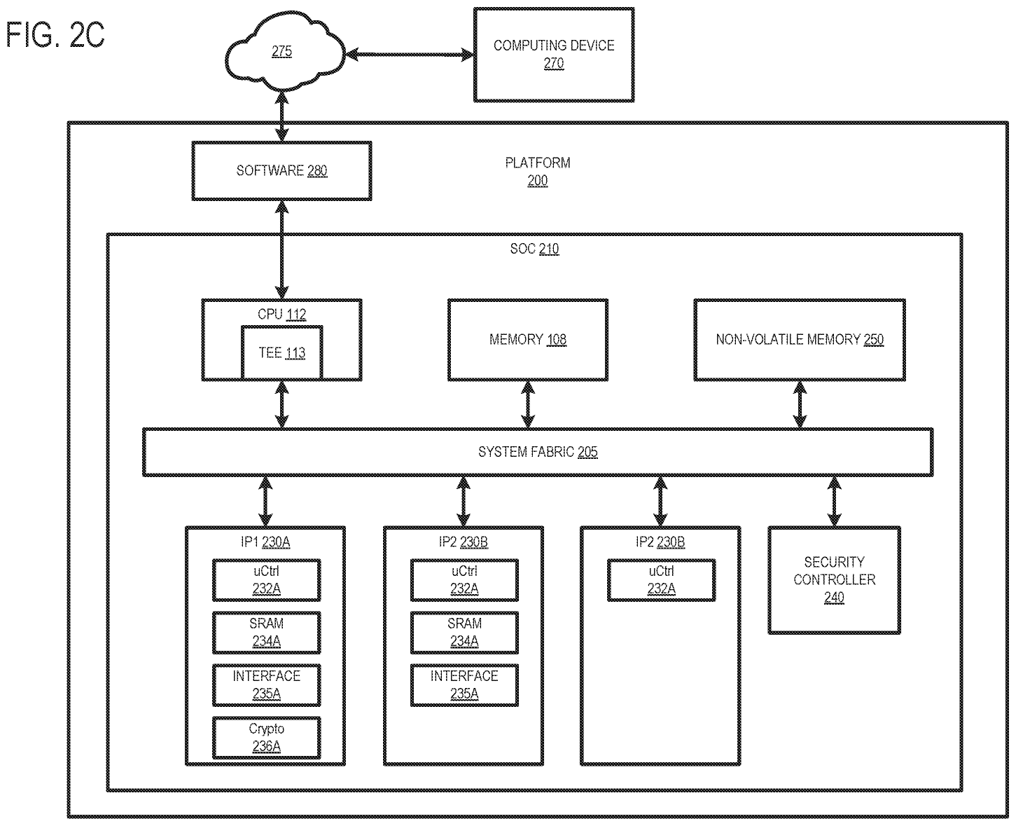

FIGS. 2A-2C are schematic illustrations of a computing platform, according to embodiments. In some examples the platform 200 may include a SOC 210 similar to computing device 100 discussed above. As shown in FIG. 2A, platform 200 includes SOC 210 communicatively coupled to one or more software components 280 via CPU 112. Additionally, SOC 210 includes other computing device components (e.g., memory 108) coupled via a system fabric 205. In one embodiment, system fabric 205 comprises an integrated on-chip system fabric (IOSF) to provide a standardized on-die interconnect protocol for coupling interconnect protocol (IP) agents (e.g., IP blocks 230A and 230B, referred to collectively herein by reference numeral 230) within SOC 210. In such an embodiment, the interconnect protocol provides a standardized interface to enable third parties to design logic such as IP agents 230 to be incorporated in SOC 210.

According to embodiment, IP agents 230 may include general purpose processors or microcontrollers 232 (e.g., in-order or out-of-order cores), fixed function units, graphics processors, I/O controllers, display controllers, etc., a SRAM 234, and may include a crypto module 236. In such an embodiment, each IP agent 230 includes a hardware interface 235 to provide standardization to enable the IP agent 230 to communicate with SOC 210 components. For example, in an embodiment in which IP agent 230 is a third-party visual processing unit (VPU), interface 235 provides a standardization to enable the VPU to access memory 108 via fabric 205.

SOC 210 also includes a security controller 240 that operates as a security engine to perform various security operations (e.g., security processing, cryptographic functions, etc.) for SOC 210. In one embodiment, security controller 240 comprises an IP agent 240 that is implemented to perform the security operations. Further, SOC 210 includes a non-volatile memory 250. Non-volatile memory 250 may be implemented as a Peripheral Component Interconnect Express (PCIe) storage drive, such as a solid state drives (SSD) or Non-Volatile Memory Express (NVMe) drives. In one embodiment, non-volatile memory 250 is implemented to store the platform 200 firmware. For example, non-volatile memory 250 stores boot (e.g., Basic Input/Output System (BIOS)) and device (e.g., IP agent 230 and security controller 240) firmware.

FIG. 2B illustrates another embodiment of platform 200 including a component 270 coupled to SOC 210 via IP 230A. In one embodiment, IP 230A operates as a bridge, such as a PCIe root port, that connects component 260 to SOC 210. In this embodiment, component 260 may be implemented as a PCIe device (e.g., switch or endpoint) that includes a hardware interface 235 to enable component 260 to communicate with SOC 210 components.

FIG. 2C illustrates yet another embodiment of platform 200 including a computing device 270 coupled to platform 200 via a cloud network 210. In this embodiment, computing device 270 comprises a cloud agent 275 that is provided access to SOC 210 via software 280.

In some examples the firmware interface(s) 285 may implement an embodiment of a firmware dashboard which extracts common elements of the firmware loading for each of the IPs, and creates a standard interface for software to load firmware into these IPs. Common elements may include the following:

Enumeration capabilities: This pertains to information that software running in external agents could use to enumerate the IP and understand what its capabilities are. This may describe, for example, if the IP has a crypto capability, if it expects a pull model (if the IP itself pulls the firmware), if it has a multi-stage loading, and other information helpful in identification of firmware for the IP device and revision identifiers.

Loader-related information: This pertains to information exchanged between the IP and external agents, with respect to where in system memory is the IP's firmware image. For example, the firmware image may be loaded from a flash storage, and thus, the loader may be required to pull the image from the flash storage. An IP may use this to pull the firmware itself if it has a ROM and crypto to establish image integrity. Otherwise, other agents may play the role of a firmware verifier (e.g., security engine 240). In that case, the security engine may use the loader-related information to verify the integrity of the firmware image.

Verifier-related information: This pertains to information related to integrity verification of the firmware image that will execute within the IP block. This information may be used by the IP hardware to either deny or accept the firmware image being loaded.

Interrupt and error statuses: This set of information relates to generic, doorbell-like events or status change events. These can be used to interrupt software components running on the IP or the host when certain events in the IP loading flow occur.

The firmware loading procedure described herein takes the above common elements and provides a unified and consistent standard interface to the external world from the IP, with respect to the firmware load. It also abstracts implementation details or differences within the IP blocks, themselves. Advantageously, external software components and controllers can implement a single unified flow for firmware load for all IPs. IPs that are not natively designed to meet the hardware standard could be enabled to use the standard via a shim or buttress-like interface, or a standalone hardware widget (e.g., firmware dashboard) could also be provided.

By using such a mechanism, each SOC agent like the OS driver, BIOS or the Security engine could enumerate all the SOC IP's as part of their boot sequence and load FW for all the IP's they are responsible for using a common SW flow. This would be similar to PCI enumeration

One example of the standard interface which may be used in enumeration is described below. In some examples the interface provides information to each agent reading it on what are its responsibilities with respect to that IP. Each software agent in a SOC can create a list of tasks it does for relevant IPs and this flow is consistent across all agents and SW components in the SOC. Some of the information captured from this interface include:

1. If the IP requires FW pushed into it or it could pull the FW from external memory

2. If the IP expects either the BIOS, the OS driver, a TEE or an external security agent to load its FW from flash

3. If the IP expects either the BIOS, the OS driver, a TEE or a security engine to authenticate its FW

4. If the IP supports loading and verifying by itself

5. Device ID and Revision ID of the IP HW so that it could be matched with an equivalent FW version in flash or storage devices

The firmware load flow can then be ported across different operating system versions, SOCs and platforms without impacting IP changes other than the configuration parameters that are used to set the enumeration bits. These may be implemented as compile time straps or parameters within the IPs.

TABLE I
IP Loader and Verifier Capabilities

| Bits | Access Type | Default | Description |
|---|---|---|---|
| 63:36 | RO | 1′h0 | RESERVED |
| 47:44 | RO | parameter | IP expects Push model |
| 43:36 | RO | 8′h0 | Reserved |
| 35:32 | RO | Parameter/ | Verifier capability expected |
| | | fuse/strap | via another SOC IP |
| | | | (Example Security IP) |
| 31:28 | RO | Parameter/ | Loader Capabilities |
| | | fuse/strap | expected via |
| | | | another SOC IP (Example |
| | | | Security IP) |
| 27:24 | RO | Parameter/ | Verifier Capability expected |
| | | fuse/strap | via IA SW/TEE |
| 23:20 | RO | Parameter/fuse/strap | Loader Capabilities expected |
| | | | via IA SW/TEE |
| 19:16 | RO | Parameter/fuse/strap | Verifier Capability expected |
| | | | via BIOS |
| 15:12 | RO | Parameter/fuse/strap | Loader Capabilities expected |
| | | | via BIOS |
| 11:8 | RO | Parameter/fuse/strap | Verifier Capability is built |
| | | | within IP itself |
| 7:4 | RO | Parameter/fuse/strap | Loader Capabilities is built |
| | | | within IP itself |
| 3:3 | RO | Parameter/fuse/strap | Inline HASHing |
| | | | supported by IP. |
| | | | There is no current usage for |
| | | | this feature in Dashboard 1.0 |
| 2:0 | RO | 3′b0 | Reserved |

TABLE 2
IP Loader and Verifier Capabilities

| Bits | Access Type | Default | Description |
|---|---|---|---|
| 63:20 | RO | 8′h0 | Reserved |
| 31:28 | RO | 4′h0 | Debug Policy/Mode enabled |
| | | | This field should be used by the IP to |
| | | | reflect anynon-production related |
| | | | states that the IP would like to |
| | | | inform the Loaders and verifiers. |
| | | | This should be used by IP's to |
| | | | reflect the below information |
| | | | 1. SOC Life Cycle states |
| | | | 2. SOC debug modes |
| | | | 3. SW defined encodings for any |
| | | | SW debug modes |
| | | | Loaders and Verifiers are |
| | | | expected to use these bits to |
| | | | detect debug situations. |
| 27:24 | RO | 8′h0 | FLF Spec version |
| 23:16 | RO | 8′h0 | Revision ID. This field should be |
| | | | connected to the PCI Revision ID of |
| | | | the IP. It along with the Device ID will |
| | | | provide a unique ID that loader and |
| | | | verifier agents check to ensure correct |
| | | | firmware is being loaded and verified |
| 15:0 | RO | 18′h0 | IP Device ID. This field should |
| | | | reflect the PCI Device ID of the IP. |
| | | | It along with the Revision ID will |
| | | | provide a unique ID that loader and |
| | | | verifier agents check to ensure correct |
| | | | firmware is being loaded and verified |

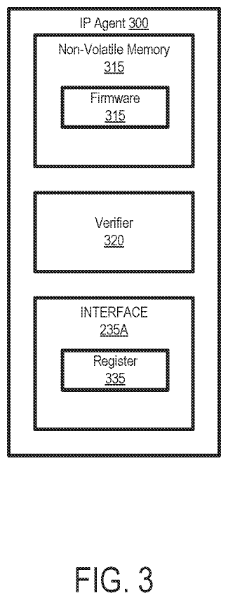

FIG. 3 is a schematic illustration of an IP agent according to an embodiment. According to one embodiment, agent 300 includes a memory 310 including firmware 315 that is executed to perform the particular function associated with the agent 300. For instance, if IP agent 300 is a video processing agent then firmware 315 may be executed at a video processing unit (VPU) of agent to perform video processing functions. In one embodiment, firmware 315 for each agent is securely reported to other platform 200 components, software 280 and/or one or more cloud components.

Agent 300 also includes a verifier 320 implemented to verify the integrity of firmware 315. In such an embodiment, verifier 320 generates measurement data by verifying the integrity of firmware 315. In a further embodiment, the integrity is verified via a hash algorithm (e.g., MD5 message-digest algorithm, Secure Hash Algorithm 1 (SHA-1)) performed on the firmware data (or image). Although shown as being implemented within agent 300, other embodiments may feature verifier 320 being implemented at an external component (e.g., Basic Input/Output System (BIOS) firmware, virtual machine manager, software driver, etc.).

Interface 330 is also included within agent 300. According to one embodiment interface 330 incudes register 335 to store the firmware load instructions and/or verification measurement data. In a further embodiment, register 335 is located at a fixed address offset from interface 330 and interface 330 is located at a standard memory address in the IP agent 300. In yet a further embodiment, register 335 is accessible via fabric 205. Table 3 shows one embodiment of register 335.

TABLE 3
Register Contents

| | Access | | |
|---|---|---|---|
| Bits | Type | Default | Description |
| 512:0 | RO | 11′h0 | HASH of the image being verified |
| | | | and loaded into the agent |

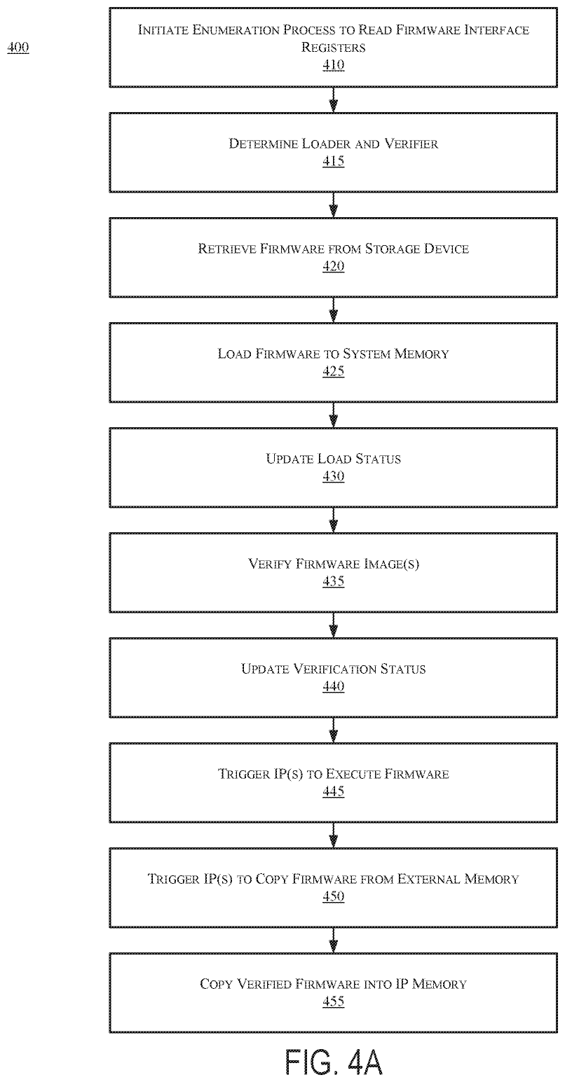

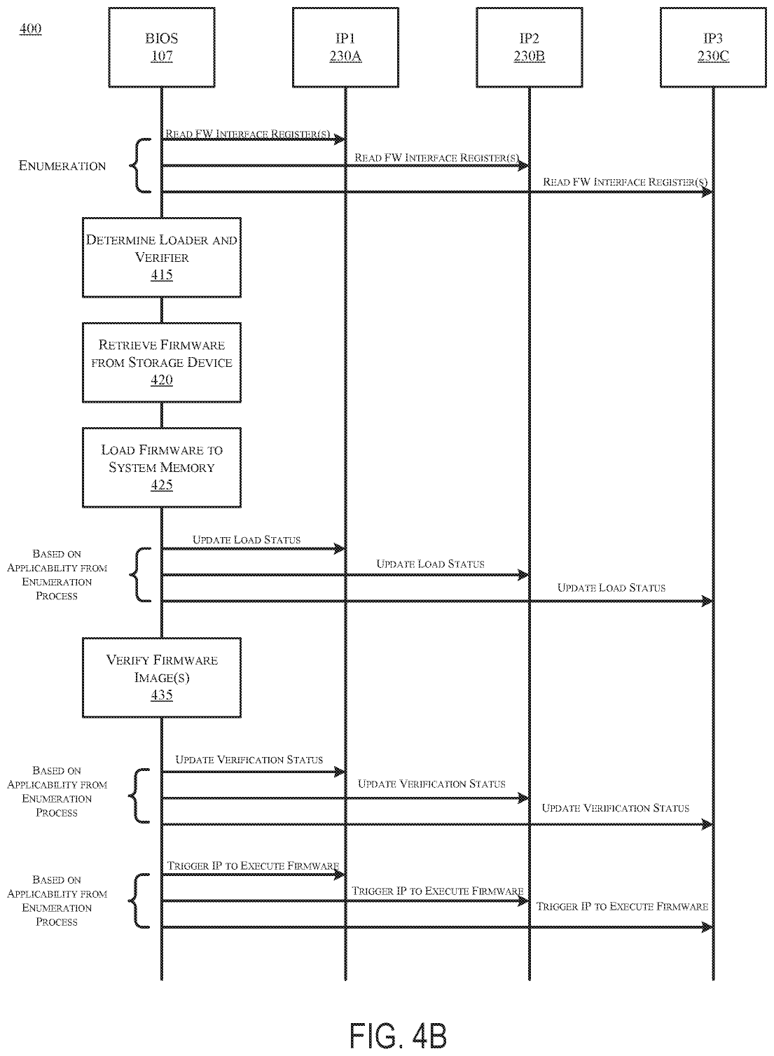

FIG. 4A is a flow diagram illustrating operations in a method 400 to implement an IP independent secure firmware load, according to embodiments, and FIG. 4B is a ping-pong diagram illustrating operations in the method 400 to implement an IP independent secure firmware load, according to embodiments In some examples, the operations depicted in FIGS. 4A and 4B may be implemented by BIOS 107 of the computing device 100.

Referring to FIGS. 4A and/or FIG. 4B, at operation 410 an enumeration process is initiated to read the firmware interface register(s) of one or more IP agents of a SOC to obtain firmware load instructions for the IP agent. Referring to FIG. 3, for example, the BIOS 107 may read firmware load instructions for the IP agent 300 from the register 335 of interface 235A. In some examples the load instructions may comprise the IP loader and verifier capabilities associated with the IP agent 300, as illustrated above with reference to Table 1 and Table 2, as illustrated in FIG. 3.

At operation 415 the IP to be loader in one or more IP agents of the SOC 100 is determined. In some examples the BIOS 107 may determine which of the IP agents of the SOC 100 need to receive a firmware update. For example, a firmware update may be performed on a periodic basis. Alternatively, the SOC 100 may receive notification from IP's in SOC 100 indicating that one or more of the IP agents (e.g., 230A, 230B, 230C) requires a firmware update.

At operation 420 the BIOS 107 retrieves an image of the firmware update from a storage device, e.g., from an external storage device, and at operation 425 the firmware image is loaded to system memory 108.

At operation 430 the BIOS 107 initiates a process to update the load status of the firmware image to be loaded onto the one or more IP agents (e.g., 230A, 230B, 230C). In some examples the load status update may be based on the enumeration data retrieved in operation 410. In some examples, after enumeration the BIOS 107 detects a loader, the BIOS sets a loading done indicator in the load status after the firmware is loaded from external storage into an addressable memory of the SOC. The loading done indication is to inform the verifier that the load stage is complete and the verification stage can begin. For example, if the IP enumeration data has the BIOS as the loader and a security controller as a verifier, then the BIOS loads the firmware from the storage device into DRAM and sets the loading done indication. This will interrupt the security controller so that it can begin the verification of the image earlier copied in DDR

At operation 435 the BIOS 107 initiates a process to verify the firmware images for which it is responsible. In some examples, verification generally involves verifying that the HASH of the image is signed by a relevant owner using asymmetric crypto like RSA. As part of this the verifier computes the HASH of the image, executes an RSA verify operation using a public key provided and ensures it matches with the HASH. It then ensures that the public key is bound to the platform by comparing it with something in the device like within the ROM code or fuses.

At operation 440 the BIOS 107 initiates a process to update the verification status of the firmware with the one or more IP agents (e.g., 230A, 230B, 230C).

At operation 445 the BIOS 107 triggers the one or more IP agents (e.g., 230A, 230B, 230C) to execute the updated firmware image. At operation 450 the BIOS 107 triggers the one or more IP agents (e.g., 230A, 230B, 230C) to copy the firmware image from external memory (e.g., the memory 108 or a memory segment of TEE 113). At operation 455 BIOS 107 triggers the one or more IP agents (e.g., 230A, 230B, 230C) to execute the firmware from external memory.

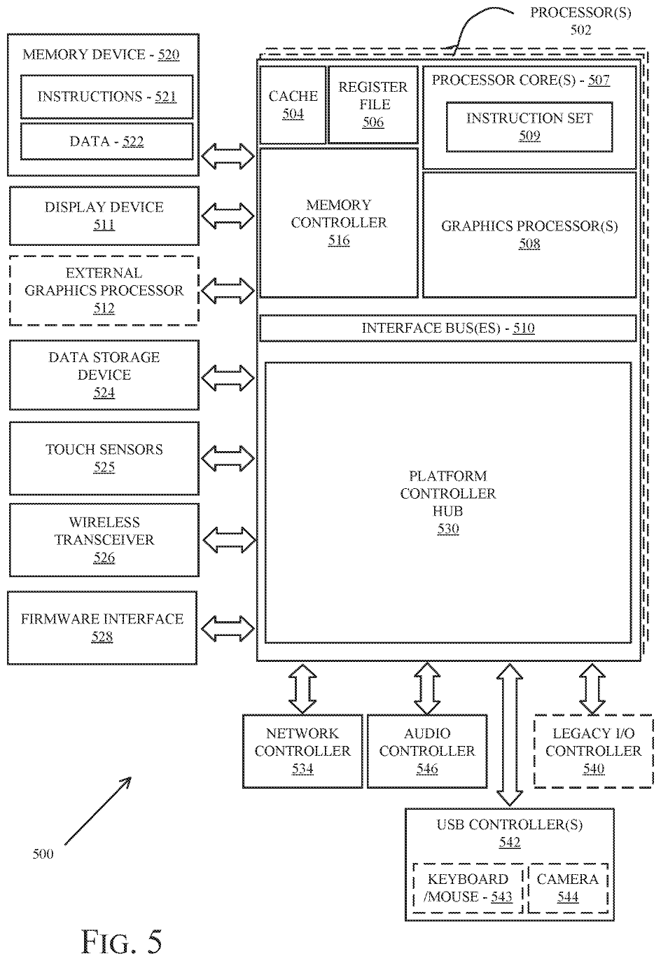

FIG. 5 is a schematic illustration of an electronic device which may be adapted to implement an IP independent secure firmware load, according to embodiments. In various embodiments, the computing architecture 500 may comprise or be implemented as part of an electronic device. In some embodiments, the computing architecture 500 may be representative, for example of a computer system that implements one or more components of the operating environments described above. In some embodiments, computing architecture 500 may be representative of one or more portions or components of a DNN training system that implement one or more techniques described herein. The embodiments are not limited in this context.

As used in this application, the terms “system” and “component” and “module” are intended to refer to a computer-related entity, either hardware, a combination of hardware and software, software, or software in execution, examples of which are provided by the exemplary computing architecture 500. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 500 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 500.

As shown in FIG. 5, the computing architecture 500 includes one or more processors 502 and one or more graphics processors 508, and may be a single processor desktop system, a multiprocessor workstation system, or a server system having a large number of processors 502 or processor cores 507. In on embodiment, the system 500 is a processing platform incorporated within a system-on-a-chip (SoC or SOC) integrated circuit for use in mobile, handheld, or embedded devices.

An embodiment of system 500 can include, or be incorporated within a server-based gaming platform, a game console, including a game and media console, a mobile gaming console, a handheld game console, or an online game console. In some embodiments system 500 is a mobile phone, smart phone, tablet computing device or mobile Internet device. Data processing system 500 can also include, couple with, or be integrated within a wearable device, such as a smart watch wearable device, smart eyewear device, augmented reality device, or virtual reality device. In some embodiments, data processing system 500 is a television or set top box device having one or more processors 502 and a graphical interface generated by one or more graphics processors 508.

In some embodiments, the one or more processors 502 each include one or more processor cores 507 to process instructions which, when executed, perform operations for system and user software. In some embodiments, each of the one or more processor cores 507 is configured to process a specific instruction set 509. In some embodiments, instruction set 509 may facilitate Complex Instruction Set Computing (CISC), Reduced Instruction Set Computing (RISC), or computing via a Very Long Instruction Word (VLIW). Multiple processor cores 507 may each process a different instruction set 509, which may include instructions to facilitate the emulation of other instruction sets. Processor core 507 may also include other processing devices, such a Digital Signal Processor (DSP).

In some embodiments, the processor 502 includes cache memory 504. Depending on the architecture, the processor 502 can have a single internal cache or multiple levels of internal cache. In some embodiments, the cache memory is shared among various components of the processor 502. In some embodiments, the processor 502 also uses an external cache (e.g., a Level-3 (L3) cache or Last Level Cache (LLC)) (not shown), which may be shared among processor cores 507 using known cache coherency techniques. A register file 506 is additionally included in processor 502 which may include different types of registers for storing different types of data (e.g., integer registers, floating point registers, status registers, and an instruction pointer register). Some registers may be general-purpose registers, while other registers may be specific to the design of the processor 502.

In some embodiments, one or more processor(s) 502 are coupled with one or more interface bus(es) 510 to transmit communication signals such as address, data, or control signals between processor 502 and other components in the system. The interface bus 510, in one embodiment, can be a processor bus, such as a version of the Direct Media Interface (DMI) bus. However, processor busses are not limited to the DMI bus, and may include one or more Peripheral Component Interconnect buses (e.g., PCI, PCI Express), memory busses, or other types of interface busses. In one embodiment the processor(s) 502 include an integrated memory controller 516 and a platform controller hub 530. The memory controller 516 facilitates communication between a memory device and other components of the system 500, while the platform controller hub (PCH) 530 provides connections to I/O devices via a local I/O bus.

Memory device 520 can be a dynamic random-access memory (DRAM) device, a static random-access memory (SRAM) device, flash memory device, phase-change memory device, or some other memory device having suitable performance to serve as process memory. In one embodiment the memory device 520 can operate as system memory for the system 500, to store data 522 and instructions 521 for use when the one or more processors 502 executes an application or process. Memory controller hub 516 also couples with an optional external graphics processor 512, which may communicate with the one or more graphics processors 508 in processors 502 to perform graphics and media operations. In some embodiments a display device 511 can connect to the processor(s) 502. The display device 511 can be one or more of an internal display device, as in a mobile electronic device or a laptop device or an external display device attached via a display interface (e.g., DisplayPort, etc.). In one embodiment the display device 511 can be a head mounted display (HMD) such as a stereoscopic display device for use in virtual reality (VR) applications or augmented reality (AR) applications.

In some embodiments the platform controller hub 530 enables peripherals to connect to memory device 520 and processor 502 via a high-speed I/O bus. The I/O peripherals include, but are not limited to, an audio controller 546, a network controller 534, a firmware interface 528, a wireless transceiver 526, touch sensors 525, a data storage device 524 (e.g., hard disk drive, flash memory, etc.). The data storage device 524 can connect via a storage interface (e.g., SATA) or via a peripheral bus, such as a Peripheral Component Interconnect bus (e.g., PCI, PCI Express). The touch sensors 525 can include touch screen sensors, pressure sensors, or fingerprint sensors. The wireless transceiver 526 can be a Wi-Fi transceiver, a Bluetooth transceiver, or a mobile network transceiver such as a 3G, 4G, or Long Term Evolution (LTE) transceiver. The firmware interface 528 enables communication with system firmware, and can be, for example, a unified extensible firmware interface (UEFI). The network controller 534 can enable a network connection to a wired network. In some embodiments, a high-performance network controller (not shown) couples with the interface bus 510. The audio controller 546, in one embodiment, is a multi-channel high definition audio controller. In one embodiment the system 500 includes an optional legacy I/O controller 540 for coupling legacy (e.g., Personal System 2 (PS/2)) devices to the system. The platform controller hub 530 can also connect to one or more Universal Serial Bus (USB) controllers 542 connect input devices, such as keyboard and mouse 543 combinations, a camera 544, or other USB input devices.

Embodiments may be provided, for example, as a computer program product which may include one or more machine-readable media having stored thereon machine-executable instructions that, when executed by one or more machines such as a computer, network of computers, or other electronic devices, may result in the one or more machines carrying out operations in accordance with embodiments described herein. A machine-readable medium may include, but is not limited to, floppy diskettes, optical disks, CD-ROMs (Compact Disc-Read Only Memories), and magneto-optical disks, ROMs, RAMs, EPROMs (Erasable Programmable Read Only Memories), EEPROMs (Electrically Erasable Programmable Read Only Memories), magnetic or optical cards, flash memory, or other type of media/machine-readable medium suitable for storing machine-executable instructions.

Moreover, embodiments may be downloaded as a computer program product, wherein the program may be transferred from a remote computer (e.g., a server) to a requesting computer (e.g., a client) by way of one or more data signals embodied in and/or modulated by a carrier wave or other propagation medium via a communication link (e.g., a modem and/or network connection).

Throughout the document, term “user” may be interchangeably referred to as “viewer”, “observer”, “speaker”, “person”, “individual”, “end-user”, and/or the like. It is to be noted that throughout this document, terms like “graphics domain” may be referenced interchangeably with “graphics processing unit”, “graphics processor”, or simply “GPU” and similarly, “CPU domain” or “host domain” may be referenced interchangeably with “computer processing unit”, “application processor”, or simply “CPU”.

It is to be noted that terms like “node”, “computing node”, “server”, “server device”, “cloud computer”, “cloud server”, “cloud server computer”, “machine”, “host machine”, “device”, “computing device”, “computer”, “computing system”, and the like, may be used interchangeably throughout this document. It is to be further noted that terms like “application”, “software application”, “program”, “software program”, “package”, “software package”, and the like, may be used interchangeably throughout this document. Also, terms like “job”, “input”, “request”, “message”, and the like, may be used interchangeably throughout this document.

In various implementations, the computing device may be a laptop, a netbook, a notebook, an ultrabook, a smartphone, a tablet, a personal digital assistant (PDA), an ultra mobile PC, a mobile phone, a desktop computer, a server, a set-top box, an entertainment control unit, a digital camera, a portable music player, or a digital video recorder. The computing device may be fixed, portable, or wearable. In further implementations, the computing device may be any other electronic device that processes data or records data for processing elsewhere.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Embodiments may be provided, for example, as a computer program product which may include one or more transitory or non-transitory machine-readable storage media having stored thereon machine-executable instructions that, when executed by one or more machines such as a computer, network of computers, or other electronic devices, may result in the one or more machines carrying out operations in accordance with embodiments described herein. A machine-readable medium may include, but is not limited to, floppy diskettes, optical disks, CD-ROMs (Compact Disc-Read Only Memories), and magneto-optical disks, ROMs, RAMs, EPROMs (Erasable Programmable Read Only Memories), EEPROMs (Electrically Erasable Programmable Read Only Memories), magnetic or optical cards, flash memory, or other type of media/machine-readable medium suitable for storing machine-executable instructions.

Some embodiments pertain to Example 1 that includes an apparatus, comprising a plurality of agents, at least one agent including a memory to store firmware to be executed by the agent to perform a function associated with the agent; and a register to store enumeration data for the firmware; a processor to initiate an enumeration process to read the enumeration data from the register of the at least one agent retrieve a firmware module from a storage device; verify the firmware module; and load the firmware module into the memory of the at least one agent.

Example 2 includes the subject matter of Example 1, wherein the processor is to transmit a message to the at least one agent to update a load status of the firmware module.

Example 3 includes the subject matter of Examples 1 and 2, wherein the firmware module is loaded using at least one of a push technique or a pull technique.

Example 4 includes the subject matter of Examples 1-3, wherein the at least one agent is to collect enumerable data from each of the plurality of agents; and discover one or more capabilities of the agent using the enumerable data.

Example 5 includes the subject matter of Examples 1-4, wherein the at least one agent is to transmit a message to trigger the at least one agent to execute the firmware module.

Example 6 includes the subject matter of Examples 1-5, wherein the at least one agent is to transmit a message to trigger the at least one agent to copy the firmware module from an external memory.

Example 7 includes the subject matter of Examples 1-6, wherein the processor is to copy the firmware module into a memory of the at least one agent.

Some embodiments pertain to Example 8 that includes a processor-implemented method, comprising initiating, in a processor, an enumeration process to read enumeration data from a register of the at least one agent of a plurality of agents, the at least one agent comprising a memory to store firmware to be executed by the agent to perform a function associated with the agent; and a register to store the enumeration data for the firmware; retrieving a firmware module from a storage device; verifying the firmware module; and loading the firmware module into the memory of the at least one agent

Example 9 includes the subject matter of Example 8, further comprising transmitting a message to the at least one agent to update a load status of the firmware module.

Example 10 includes the subject matter of Examples 8 and 9, wherein the firmware module is loaded using at least one of a push technique or a pull technique.

Example 11 includes the subject matter of Examples 8-10, further comprising collecting enumerable data from each of the plurality of agents, and discovering one or more capabilities of the agent using the enumerable data.

Example 12 includes the subject matter of Examples 8-11, further comprising transmitting a message to trigger the at least one agent to execute the firmware module.

Example 13 includes the subject matter of Examples 8-12, further comprising transmitting a message to trigger the at least one agent to copy the firmware module from an external memory.

Example 14 includes the subject matter of Examples 8-13, wherein the processor is to copy the firmware module into a memory of the at least one agent.

Some embodiments pertain to Example 15, that includes at least one non-transitory computer readable medium having instructions stored thereon, which when executed by a processor, cause the processor to initiate, in the processor, an enumeration process to read enumeration data from a register of the at least one agent of a plurality of agents, the at least one agent comprising a non-volatile memory to store firmware to be executed by the agent to perform a function associated with the agent; and a register to store the enumeration data for the firmware; retrieve a firmware module from a storage device; verify the firmware module; and load the firmware module into the non-volatile memory of the at least one agent.

Example 16 includes the subject matter of Example 15, wherein the processor is to transmit a message to the at least one agent to update a load status of the firmware module.

Example 17 includes the subject matter of Examples 15 and 16, wherein the firmware module is loaded using at least one of a push technique or a pull technique.

Example 18 includes the subject matter of Examples 15-17, wherein the at least one agent is to collect enumerable data from each of the plurality of agents; and discover one or more capabilities of the agent using the enumerable data.

Example 19 includes the subject matter of Examples 15-18, wherein the at least one agent is to transmit a message to trigger the at least one agent to execute the firmware module.

Example 20 includes the subject matter of Examples 15-19, wherein the at least one agent is to transmit a message to trigger the at least one agent to copy the firmware module from an external memory.

Example 21 includes the subject matter of Examples 15-20, wherein the processor is to copy the firmware module into a memory of the at least one agent.

The subject matter has been described above with reference to specific embodiments. Persons skilled in the art, however, will understand that various modifications and changes may be made thereto without departing from the broader spirit and scope of the subject matter as set forth in the appended claims. The foregoing description and drawings are, accordingly, to be regarded in an illustrative rather than a restrictive sense.

What is claimed is:

1. An apparatus comprising:
a plurality of agents, at least one agent including:
a memory to store firmware to be executed by the agent to perform a function associated with the agent; and
a register to store enumeration data for the firmware; and
a processor to:
initiate an enumeration process to read the enumeration data from the register of the at least one agent;
retrieve a firmware module from a storage device;
verify the firmware module; and
load the firmware module into the memory of the at least one agent.

2. The apparatus of claim 1, wherein the processor is to:
transmit a message to the at least one agent to update a load status of the firmware module.

3. The apparatus of claim 1, wherein the firmware module is loaded using at least one of a push technique or a pull technique.

4. The apparatus of claim 3, wherein the at least one agent is to:
collect enumerable data from each of the plurality of agents; and
discover one or more capabilities of the agent using the enumerable data.

5. The apparatus of claim 4, wherein the at least one agent is to transmit a message to trigger the at least one agent to execute the firmware module.

6. The apparatus of claim 5, wherein the at least one agent is to transmit a message to trigger the at least one agent to copy the firmware module from an external memory.

7. The apparatus of claim 6, wherein the processor is to copy the firmware module into a memory of the at least one agent.

8. A processor-implemented method, comprising:
initiating, in a processor, an enumeration process to read enumeration data from a register of the at least one agent of a plurality of agents, the at least one agent comprising:
a memory to store firmware to be executed by the agent to perform a function associated with the agent; and
a register to store the enumeration data for the firmware;
retrieving a firmware module from a storage device;
verifying the firmware module; and
loading the firmware module into the memory of the at least one agent.

9. The method of claim 8, further comprising transmitting a message to the at least one agent to update a load status of the firmware module.

10. The method of claim 9, wherein the firmware module is loaded using at least one of a push technique or a pull technique.

11. The method of claim 10, further comprising
collecting enumerable data from each of the plurality of agents; and
discovering one or more capabilities of the agent using the enumerable data.

12. The method of claim 11, further comprising:
transmitting a message to trigger the at least one agent to execute the firmware module.

13. The method of claim 12, further comprising transmitting a message to trigger the at least one agent to copy the firmware module from an external memory.

14. The method of claim 13, further comprising copying the firmware module into a memory of the at least one agent.

15. At least one non-transitory computer readable medium having instructions stored thereon, which when executed by a processor, cause the processor to:
initiate, in the processor, an enumeration process to read enumeration data from a register of the at least one agent of a plurality of agents, the at least one agent comprising:
a non-volatile memory to store firmware to be executed by the agent to perform a function associated with the agent; and
a register to store the enumeration data for the firmware;
retrieve a firmware module from a storage device;
verify the firmware module; and
load the firmware module into the non-volatile memory of the at least one agent.

16. The computer readable medium of claim 15, further comprising instruction which, when executed by processor, cause the processor to:
transmit a message to the at least one agent to update a load status of the firmware module.

17. The computer readable medium of claim 16, wherein the firmware module is loaded using at least one of a push technique or a pull technique.

18. The computer readable medium of claim 17, wherein the at least one agent is to:
collect enumerable data from each of the plurality of agents; and
discover one or more capabilities of the agent using the enumerable data

19. The computer readable medium of claim 18, wherein the at least one agent is to transmit a message to trigger the at least one agent to execute the firmware module.

20. The computer readable medium of claim 19, wherein the at least one agent is to transmit a message to trigger the at least one agent to copy the firmware module from an external memory.

21. The computer readable medium of claim 20, wherein the processor is to copy the firmware module into a memory of the at least one agent.
